(19) United States
(12) Patent Application Publication
(10) Pub. No.: US 2008/0264847 A1
(43) Pub. Date: Oct. 30, 2008

(54) Laser welded water softener screen assembly

(75) Inventors: Keith A. Emerson, Groveport, OH (US); Christopher T. Hughes, Columbus, OH (US)

Correspondence Address: MUELLER AND SMITH, LPA;MUELLER-SMITH BUILDING, 7700 RIVERS EDGE DRIVE, COLUMBUS, OH, 43235, US

(73) Assignee: Wm. R. Hague, Inc., Groveport, OH (US)

(21) Appl. No.: 11/789,918

(22) Filed: Apr. 26, 2007

(51) Int. Cl. B01D 15/00; B29C 65/16; C02F 1/42

(52) U.S. Cl. 210/190; 156/272.8; 210/289; 210/291

(57) ABSTRACT

A water softener tank houses resin beads retained within an upper screen assembly and a lower screen assembly. The upper and lower screens are formed of material transparent to a given wavelength of a laser. The tank is formed of material that absorbs the given laser wavelength. The upper and lower screens are directly laser welded to the tank.

### CROSS-REFERENCE TO RELATED APPLICATIONS

None

### STATEMENT REGARDING FEDERALLY SPONSORED RESEARCH

Not applicable.

### BACKGROUND

The present disclosure relates to water treatment systems, sometimes commonly known as “water softening systems” or simply “water softeners”, and more particularly to a unique screen assembly design and to its manufacture.

Resin-type ion exchange devices have many uses, such as the softening of water. As the water to be processed is passed through the resin-filled tank, ions in the fluid to be processed, e.g., calcium, are exchanged with ions found in the resin, e.g., sodium, thereby removing objectionable ions found in the water. During this ion exchange process, the ability of the resin to exchange ions gradually is reduced. That is, the resin bed becomes exhausted and, thereafter, water will flow therethrough in unprocessed form.

The capacity of the ion exchange resin bed can be determined from the volume of resin used and the particular type of resin. The concentration of contaminant(s) in the water to be processed can be determined, at least on an average basis. Thus, the volume of water that can be processed by a particular water treatment unit is known. Once that capacity of water has been treated, the bed must be regenerated.

Regeneration of the ion exchange resins typically involves chemically replacing the objectionable ions from the resin with less objectionable ions, e.g., replacing calcium with sodium ions. This regeneration process requires the suspension of the treatment process; thus, necessitating the water to bypass the ion exchange resin tank. At the same time as the ion exchange resin is regenerated, the bed can be backwashed in order to remove trapped particulate matter, the resin tank can be rinsed to remove objectionable soluble materials, an application of sterilization agent to prevent bacterial growth can be accomplished, etc. All of these operations are known in the art.

Water flow between the resin tank and the regenerating or salt bed is controlled by a brine valve, which as its name implies, must have the ability to divert brine from the salt bed into and through the resin bed to reactivate or regenerate it. Typically, water softeners are composed of two tanks: a brine tank and a resin bed or bead tank. Appropriate piping along with the brine valve accomplishes the water softening operations, as described above. Most cabinets that house the brine tank and the resin tank are formed from polymeric materials (plastics). Attachment of screens, brackets, and other components to the cabinet interior adds to the expense of the operation and takes up valuable space that otherwise could be devoted, for example, to additional resin beads with consequent increase in the capacity to soften water.

The present disclosure is to improving the design interior components of a resin bead tank.

### BRIEF SUMMARY

A water softener tank houses resin beads retained within an upper screen assembly and a lower screen assembly. The upper and lower screens are formed of material transparent to a given wavelength of a laser. The tank is formed of material that absorbs the given laser wavelength. The upper and lower screens are directly laser welded to the tank.

Advantages of the disclosed laser welded screen assembly include an increased screen surface area by dint of said laser attachment to the tank. Another advantage is that the upper and lower screens can be placed further apart inside the tank. A resultant advantage is an increased volume of the tank for housing an increased amount of ion exchange resin beads. These and other advantages will be apparent to those skilled in the art.

### BRIEF DESCRIPTION OF THE DRAWINGS

For a fuller understanding of the nature and advantages of the present disclosure, reference should be had to the following detailed description taken in connection with the accompanying drawings, in which:

FIG. 1 is a front elevational view of the water softener resin tank;

FIG. 2 is a top view of the water softener resin tank in FIG. 1;

FIG. 3 is a cross-sectional view taken along line 3-3 of FIG. 2;

FIG. 4 is an overhead view of one of the laser welded screen assemblies; and

FIG. 5 is a cross-sectional view taken along line 5-5 of FIG. 4.

The drawings will be described in further detail below.

### DETAILED DESCRIPTION

Screen assemblies heretofore have been affixed to the inside of the resin bead tank by screws using gaskets, for example. Stainless steel screws are required to ward off corrosion and the gaskets are an additional expense item. This assembly technique takes up space by limiting the size (area) of the screens by virtues of the flanges and channels to affect a good gasket seal. The volume of the interior additionally is reduced by such sealing technique.

The inventive design and assembly technique obviates the gasket sealing system to expand the screen surface area and reduce the height of the gasket sealing system. The net result is to increase the interior volume allocable to resin beads and simplifies attachment of the screen assembly, also making robotic assembly possible.

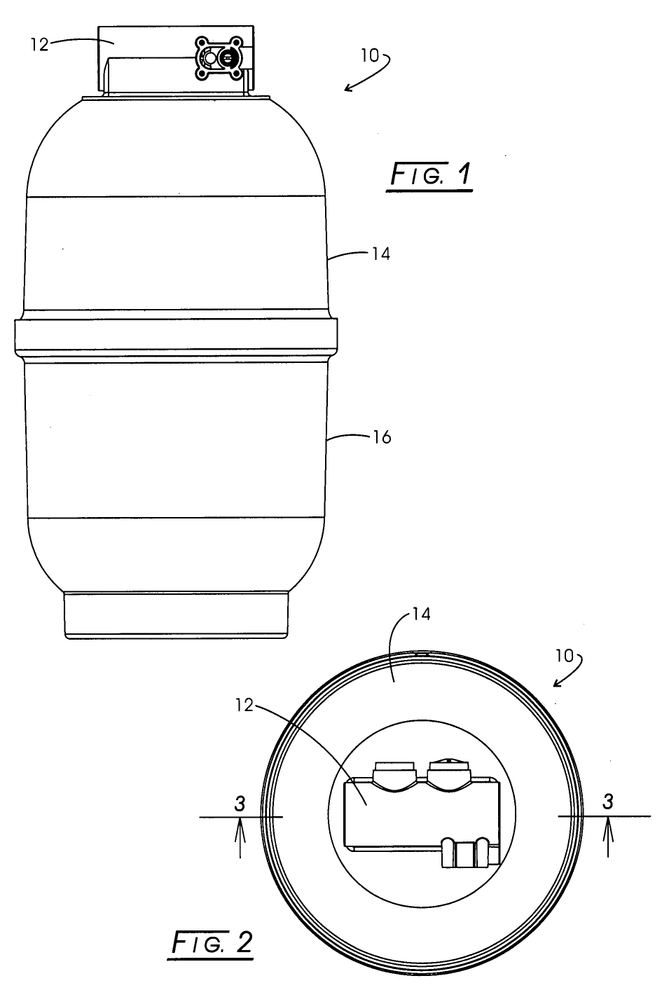

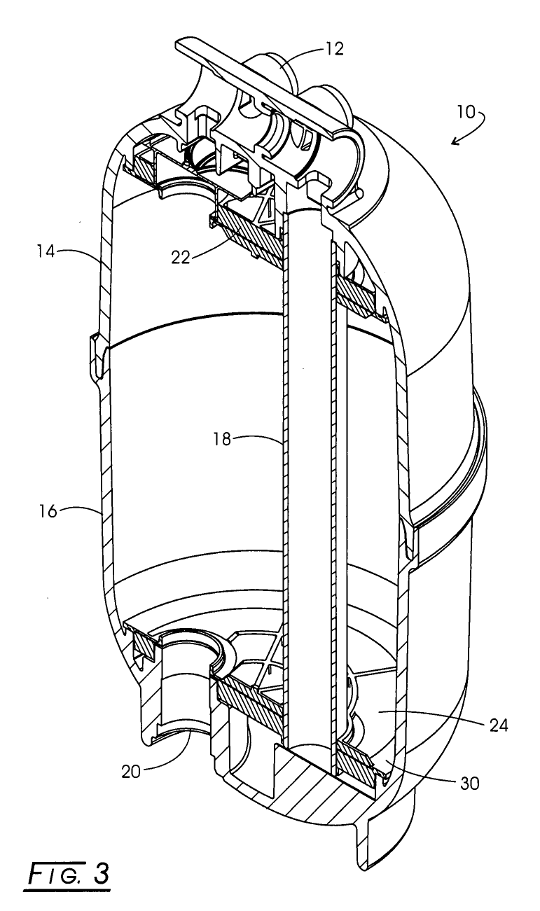

A resin bead water tank, 10, is seen in FIGS. 1 and 2 with a conventional water valve assembly, 12, atop tank 10. Tank 10 conveniently is cylindrical in shape for manufacturing ease and cost reduction; although, any shape can be used. As seen in FIG. 3, tank 10 is formed from an upper outer shell half, 14, and a lower shell half, 16, conveniently induction welded together; although any mode of attachment can be used, as well as one-piece and other multi-piece configurations, as is necessary, desirable, or convenient. Other conventional interior components are provided, such as, for example, an interior water flow tube, 18, resin bead fill mouth, 20, and the like.

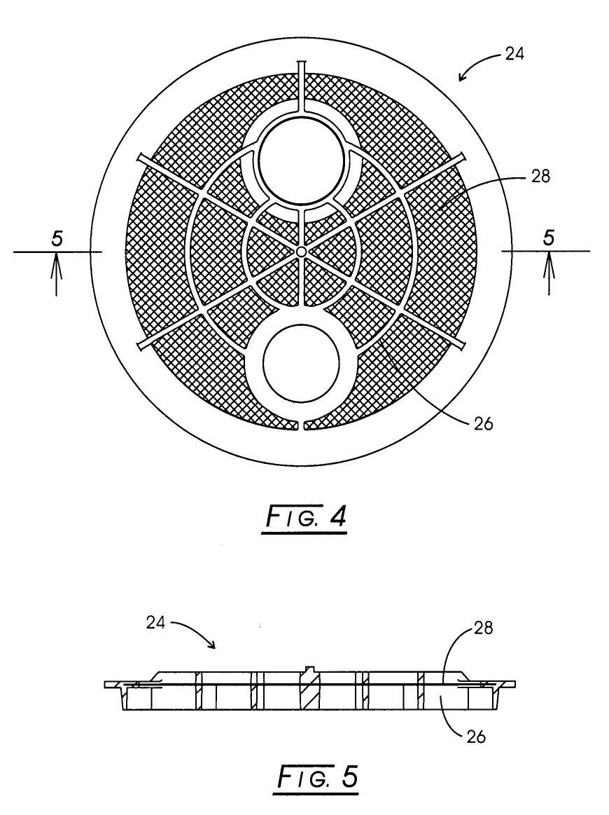

Of primary interest to the present disclosure are an upper resin bead screen assembly, 22, and a lower resin bead screen assembly, 24. Screen assembly 24, for example, is composed of a support grid, 26, and a mesh screen, 28, having an apertured opening of a size to retain the resin, as seen in FIGS. 4 and 5. Screen assemblies 22 and 24 capture resin beads, not shown in the drawings, within tank 10. Much of the description will refer specifically to screen support assembly 24 to illustrate the present invention, it being understood that screen assembly 22 is of similar construction and material requirements.

Support grid 26 is composed of a material transparent to the output wavelength of the laser (not shown in the drawings) used to laser weld screen assemblies 22 and 24 in place. One such useful industrial laser is a Model SP-200C-0001, 200 watt fiber laser, SPI Lasers LLC, Santa Clara, Calif., which has an output beam of 650-680 nm and 1050-1250 nm. In order for such welding to conveniently be accomplished cost effectively at a commercial manufacturing facility support grid 26 is transparent to the laser beam. Conveniently, a transparent polymeric material, such as natural polypropylene, can be used for forming support grid 26.

In FIG. 3, an outer flange, 30, of support grid 26 mates with a vertical flange, 32, carried by lower shell half 16. It is flange 32 that needs to be opaque (absorb) the laser beam used. One convenient material for this purpose is black polypropylene, optionally glass reinforced. For manufacturing economy, shell halves 14 and 16 may be entirely formed from such laser absorbing material. The laser beam, then, will be circumscribe the entire circumference of the flanges 30 and 32 to weld support grid 26 to shell 16 without the need for any washers, gaskets, or other sealing pieces for achieving a water-tight seal. As mentioned above, the same arrangement and requirements can be used to affix screen assembly 22 to upper shell half 14.

While the laser welded screen assembly has been described with reference to various embodiments, those skilled in the art will understand that various changes may be made and equivalents may be substituted for elements thereof without departing from the scope and essence of the disclosure. In addition, many modifications may be made to adapt a particular situation or material to the teachings of the disclosure without departing from the essential scope thereof. Therefore, it is intended that the laser welded screen assembly not be limited to the particular embodiments disclosed, but that the laser welded screen assembly will include all embodiments falling within the scope of the appended claims. In this application all units are in the metric system and all amounts and percentages are by weight, unless otherwise expressly indicated. Also, all citations referred herein are expressly incorporated herein by reference.

I claim:

1. In a water softener tank for housing resin beads retained within an upper screen assembly and a lower screen assembly, the improvement comprising:
(a) said upper and lower screens formed of material transparent to a given wavelength of a laser;
(b) said tank formed of material that absorbs said given laser wavelength; and
(c) said upper and lower screens directly laser welded to said tank.

2. The improved water softener tank of claim 1, wherein said screens comprise a support grid formed of material transparent to a given wavelength of a laser and a screen affixed thereto.

3. The improved water softener tank of claim 2, wherein said support grid is formed from natural polypropylene.

4. The improved water softener tank of claim 1, wherein said tank is formed from black polypropylene.

5. The improved water softener tank of claim 4, wherein said black polypropylene is glass fiber reinforced.

6. A method for affixing screen assemblies to a water softened tank that houses resin beads retained within an upper screen assembly and a lower screen assembly, which comprises the steps of:
(a) providing said upper and lower screens formed of material transparent to a given wavelength of a laser;
(b) providing said tank formed of material that absorbs said given laser wavelength; and
(c) laser welding said upper and lower screens directly to said tank.

7. The method of claim 1, wherein said screens comprise a support grid formed of material transparent to a given wavelength of a laser and a screen affixed thereto.

8. The method of claim 7, wherein said support grid is formed from natural polypropylene.

9. The method of claim 6, wherein said tank is formed from black polypropylene.

10. The method of claim 9, wherein said black polypropylene is glass fiber reinforced.
